(19) United States
(12) Patent Application Publication
(10) Pub. No.: US 2024/0427910 A1
(43) Pub. Date: Dec. 26, 2024

(54) MICROARCHITECTURES FOR SECURE COMPUTING SYSTEMS

(71) Applicant: QUALCOMM Incorporated, San Diego, CA (US)

(72) Inventors: Nicolas Thaddee COURTOIS, Mougins (FR); Gilles BRIAND, Mougins (FR); Florian Reneld Ghislain CAULLERY, Cannes (FR); Anton DUMAS, Odenas (FR)

(21) Appl. No.: 18/338,111

(22) Filed: Jun. 20, 2023

(51) Int. Cl. G06F 21/60

(52) U.S. Cl. CPC G06F 21/604; G06F 21/602

(57) ABSTRACT

Systems and techniques are provided for providing microarchitectures for secure computing systems. For example, a process can include obtaining a first instruction associated with a security operation, and, based on the first instruction associated with the security operation, executing, by first one or more computation modules of a plurality of computation modules, the security operation and executing, by second one or more computation modules of the plurality of computation modules, first one or more dummy operations in parallel with the security operation. The process includes obtaining a second instruction associated with a general operation and based on the second instruction associated with the general operation, executing, by third one or more computation modules of the plurality of computation modules, the general operation and executing, by fourth one or more computation modules of the plurality of computation modules, second one or more dummy operations in parallel with executing the general operation.

### FIELD

Aspects of the present disclosure relate to systems and techniques for providing microarchitectures for secure computing systems.

### BACKGROUND

Computing devices often employ various techniques to protect data. As an example, data may be subjected to encryption and decryption techniques in a variety of scenarios, such as writing data to a storage device, reading data from a storage device, writing data to or reading data from a memory device, encrypting and decrypting blocks and/or volumes of data, encrypting and decrypting digital content, performing inline cryptographic operations, etc. Such encryption and decryption operations are often performed, at least in part, using a security information asset, such as a cryptographic key, a derived cryptographic key, etc. Certain scenarios exist in which attacks are performed in an attempt to obtain such security information assets. Accordingly, it is often advantageous to implement systems and techniques to protect such security information assets.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for providing microarchitectures for secure computing systems. According to at least one example, a method is provided for providing microarchitectures for secure computing systems. The method includes: obtaining a first instruction associated with a security operation; based on the first instruction associated with the security operation: executing, by first one or more computation modules of a plurality of computation modules, the security operation; and executing, by second one or more computation modules of the plurality of computation modules, first one or more dummy operations in parallel with the security operation; obtaining a second instruction associated with a general operation; and based on the second instruction associated with the general operation: executing, by third one or more computation modules of the plurality of computation modules, the general operation; and executing, by fourth one or more computation modules of the plurality of computation modules, second one or more dummy operations in parallel with executing the general operation.

In another example, an apparatus for providing microarchitectures for secure computing systems is provided that includes a memory comprising instructions and a processor coupled to the memory. The processor is configured to: obtain a first instruction associated with a security operation; based on the first instruction associated with the security operation; execute, by first one or more computation modules of a plurality of computation modules, the security operation; and execute, by second one or more computation modules of the plurality of computation modules, first one or more dummy operations in parallel with the security operation; obtain a second instruction associated with a general operation; and based on the second instruction associated with the general operation: execute, by third one or more computation modules of the plurality of computation modules, the general operation; and execute, by fourth one or more computation modules of the plurality of computation modules, second one or more dummy operations in parallel with executing the general operation.

In another example, a non-transitory computer-readable medium is provided that has stored thereon instructions that, when executed by one or more processors, cause the one or more processors to: obtain a first instruction associated with a security operation; based on the first instruction associated with the security operation: execute, by first one or more computation modules of a plurality of computation modules, the security operation; and execute, by second one or more computation modules of the plurality of computation modules, first one or more dummy operations in parallel with the security operation; obtain a second instruction associated with a general operation; and based on the second instruction associated with the general operation: execute, by third one or more computation modules of the plurality of computation modules, the general operation; and execute, by fourth one or more computation modules of the plurality of computation modules, second one or more dummy operations in parallel with executing the general operation.

In another example, an apparatus for providing microarchitectures for secure computing systems is provided. The apparatus includes: means for obtaining a first instruction associated with a security operation; means for executing, based on the first instruction associated with the security operation, by first one or more computation means of a plurality of computation means, the security operation; and means for executing, based on the first instruction associated with the security operation, by second one or more computation means of the plurality of computation means, first one or more dummy operations in parallel with the security operation; means for obtaining a second instruction associated with a general operation; means for executing, based on the second instruction associated with the general operation, by third one or more computation means of the plurality of computation means, the general operation; and means for executing, based on the second instruction associated with the general operation, by fourth one or more computation means of the plurality of computation means, second one or more dummy operations in parallel with executing the general operation.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a diagram illustrating how a security operation can reveal specific moments in time where sensitive data are processed, in accordance with some examples of the present disclosure;

FIG. 2A is a diagram illustrating example differences in aspect and structure of instructions executed by a processor, in accordance with some examples of the present disclosure;

FIG. 2B is a diagram illustrating example instruction execution aspects, in accordance with some examples of the present disclosure;

FIG. 3 is a block diagram illustrating an example of a computing device, in accordance with some examples of the present disclosure;

FIG. 4 is a block diagram illustrating and example microarchitecture for secure computing systems, in accordance with some examples of the present disclosure;

FIG. 5A and FIG. 5B are diagrams illustrating example instruction formats with security enhancements, in accordance with some examples of the present disclosure;

FIG. 6A is a diagram illustrating example timing waveforms for instructions executed in parallel, in accordance with some examples of the present disclosure;

FIG. 6B illustrates a diagram illustrating example instruction execution waveforms extended in time with dummy operations, in accordance with some examples of the present disclosure;

FIG. 7 is a flow diagram illustrating example of a process for executing a mix of non-security and security operations, in accordance with some examples of the present disclosure;

FIG. 8 is a diagram illustrating an example of a computing system, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Cryptographic ciphers can be used for encryption and decryption of electronic data. A symmetric cryptographic cipher uses the same key (e.g., referred to as a secret key or a private key) for encryption and decryption. An asymmetric cryptographic cipher uses a private key and a public key shared between parties. Asymmetric cryptographic ciphers can also be referred to as public-key cryptography (PKC). Examples of symmetric cryptographic ciphers include Advanced Encryption Standard (AES), Data Encryption Standard (DES), Blowfish, Ascon, Keccak, and International Data Encryption Algorithm (IDEA), among various others. In some examples, symmetric ciphers such as AES can be used to implement fast and efficient encryption and decryption. However, because the same key is used for encryption and decryption, the private keys of a symmetric cipher must be distributed to the parties in a way that safeguards the secrecy of the private keys. For example, PKC or asymmetric cipher techniques are often used to perform key distribution for symmetric ciphers (e.g., Diffie-Hellman).

As an example, a security information asset may be a cryptographic key used for encrypting and/or decrypting data used by a computing device. Such a security information asset may be stored in secure information storage. In some cases, the secure information storage can include a security information asset storage device). (e.g., one time programmable (OTP) storage, non-volatile memory device, flash storage device, etc.). Security information assets may be obtained from the security information asset storage device during execution of a computing device (e.g., at boot, reboot and/or during updates), stored in a separate storage device, and provided as needed to security components (e.g., cryptographic engines, key tables, key derivation functions, etc.) for performing security operations (e.g., encryption and/or decryption of data). Security information assets so obtained may be directly used by any number of security components and/or may be used for deriving additional security information assets (e.g., derived keys used by cryptographic engines for encrypting and/or decrypting data), which is an example of a security operation. In some cases, security operations can include other steps or transformations using security information assets without departing from the scope of the present disclosure.

In some examples, a security information asset is obtained from a security information asset storage device. As an example, a security information asset may be obtained from a security information asset storage device when a computing device boots, reboots, and/or updates to be used for various security operations (e.g., encryption and/or decryption operations, key derivation operations, other steps or transformations performed using a security information asset, etc.). In some examples, the security information asset is obtained at a randomizing engine. In some examples, a randomizing engine is any hardware, software, firmware, or any combination thereof that exists within a secure execution environment of a computing device. In some examples, a secure execution environment is any portion of a computing device that is a secure area of the computing device. Examples of secure execution environments include, but are not limited to, trusted management environments, trusted execution environments, trust zones, trusted platform modules, secure components, secure elements, etc. In some examples, the security information asset storage device is a read only storage device, such as a read-only memory device, a one time programmable storage device, etc. In some examples, the security information asset storage device is a re-programmable storage device such as a non-volatile memory device, a flash storage device, etc. In some examples, a security information asset may be obtained one time from the storage information asset storage device once per boot or reboot of a computing device. A security information asset (e.g., a cryptographic key) may be stored on a security information asset storage device in a masked form or an unmasked form.

In some aspects, as discussed above, security components of a computing device may require a security information asset (e.g., a cryptographic key) to perform one or more security operations (e.g., encrypting and/or decrypting data, generating derivative cryptographic keys, any other steps and or transformations performed using a security information asset, etc.).

However, repeated reuse of security information assets may allow an attacker to use various techniques to obtain all or any portion of a security information asset, which may potentially compromise the security of a computing device. As an example, an attacker may perform a side channel attack by using a measurement device (e.g., an oscilloscope) to measure any number of characteristics of a computing device as it operates (e.g., voltages, power, electromagnetic outputs, timing information, sound, temperature, etc.). As another example, an attacker may employ fault injection techniques. In some cases, an attacker can utilize a machine learning (ML) model (e.g., a deep learning neural network) to aid in a side channel attack.

Such attacks may be of limited use when performed once, or a relatively few number of times, but may have increased effectiveness when performed a larger number of times. As such, security information assets become more vulnerable while being reused when such techniques are being used. As an example, measuring one or more characteristics of the operation of a computing device when operations transferring security information assets are performed, or when performing operations using security information assets, etc. (collectively referred to herein as security operations) may allow an attacker to obtain all or any portion of a security information asset, thereby potentially compromising the security of the computing device.

In some cases, if an attacker can determine the timing of operations transferring security operations, a measurement device can capture characteristics of the computing device at a high resolution on the time scale. In some cases, the amount of data that can be captured by an attacker can be limited by an amount of storage available in a measurement device. In one illustrative example, an oscilloscope may include a measurement buffer (e.g., memory) that can store at most one million measurements. In some cases, if an attacker can determine the timing of a 100 millisecond (ms) security operation within one ms, the measurement time scale can be approximately 100 nanosecond (ns). However, if the timing of the 100 ms operation is unknown to the attacker, the measurement time scale (e.g., 1 microsecond, 10 microseconds, and/or any other suitable timescale) can be significantly longer than the measurement timescale when timing information is known. In some cases, the data transfer, data storage, and/or data processing requirement for longer measurement timescales can be significantly more expensive to store and process on an attacker's device (e.g., a high-order differential power analysis, a deep learning ML attack, or the like) to extract useful information relative to an attack where timing information is known.

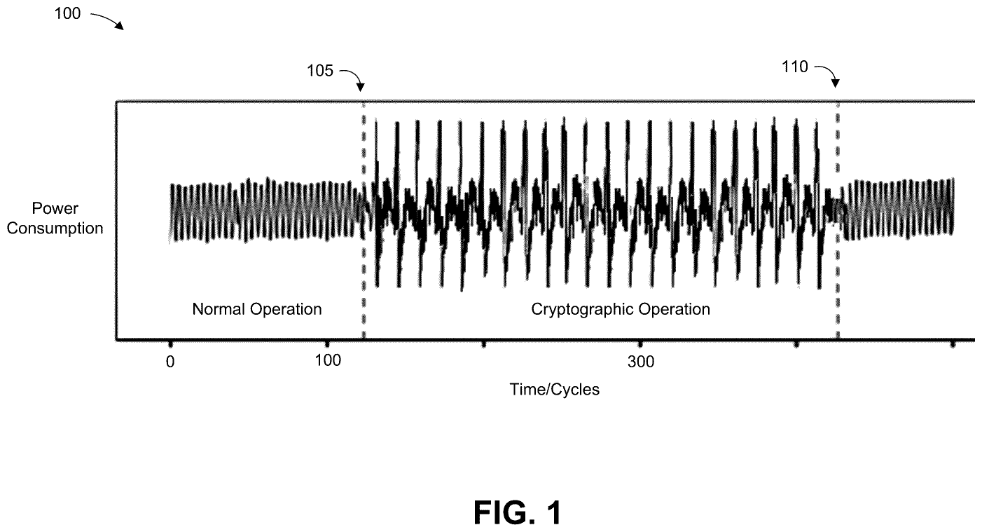

FIG. 1 provides illustrates a waveform 100 of a security operation that may reveal timing information to an attacker. For example, an attacker may attempt to analyze the waveform 100 to obtain information about one or more precise moments in time when the most sensitive security information assets are being processed. As illustrated, power fluctuations between a beginning 105 and an end 110 of an AES encryption operation (e.g., a security operation) can differ from power fluctuations before the beginning 105 and after the end 110 of the AES encryption operation can differ from the power fluctuations during the AES encryption operation. While an AES encryption option is provided as an example, other security operations, including but not limited to number theoretic transform (NTT) computations, matrix vector multiplication (A*y), r and r.G multiplication (e.g., elliptic curve point multiplication) events (e.g., for an elliptic curve digital signature algorithm (ECDSA)), security hash algorithms, (e.g., SHA-256, SHA-3), McEliece cryptography, bit flipping key encapsulation (BIKE), Hamming quasi-cycling (HQC) encryption, hash-based message authentication code (e.g., HMAC-512), RNG seeding, and/or any combination thereof may also reveal information to an attacker through a side channel attack.

In some cases, an attacker using a side channel attack or a fault injection attack repetitively as a cryptographic key is being transmitted and/or received (e.g., when obtained from a security information asset storage device at boot time, when obtained from a different storage device, when provided to security components for use in performing security operations, etc.), used to derive other cryptographic keys, etc. may be able to deduce the cryptographic key, and thus be able to use the key to decrypt data on the computing device and/or encrypt potentially malicious data using the correct key, which may then be used by the computing device.

Many techniques have been developed to reduce the vulnerability of security operations. For example, some techniques can include hiding security operations, imposing variable timing, performing specialized operations, adding redundant operations, or the like. In some cases, one or more techniques can be implemented in software executed by a computing system. However, in some cases, security operations may remain identifiable due to microarchitectural differences in instruction aspect and/or execution between instructions carried out during security operations and instructions that do not interface with security information assets (referred to herein as general operations). In some cases, the systems and techniques described herein may prioritize obscuring timing of security instructions using variable timing (e.g., adding dummy cycles) and/or hiding security operations by executing dummy operations over constant timing requirements that are sometimes used in secure computing systems. In some implementations, while constant timing can be required for a strict subsystem during instruction cycles that are required for performing a security operation, additional cycles that are not required for performing the security instruction can be added at the microarchitectural level to make precise identification of the timing of a security operation more difficult, even in the presence of recorded power and/or electromagnetic emanation traces. For example, the constant timing cycles of the security operation can occur at variable time moments (e.g., by adding variable numbers of dummy cycles before and/or after the constant time cycles of the security operation) and/or the security operation can be accompanied by dummy operations. In some cases, dummy operations can also be repeated periodically when no security operations are being processed to further obscure the timing of the security operations.

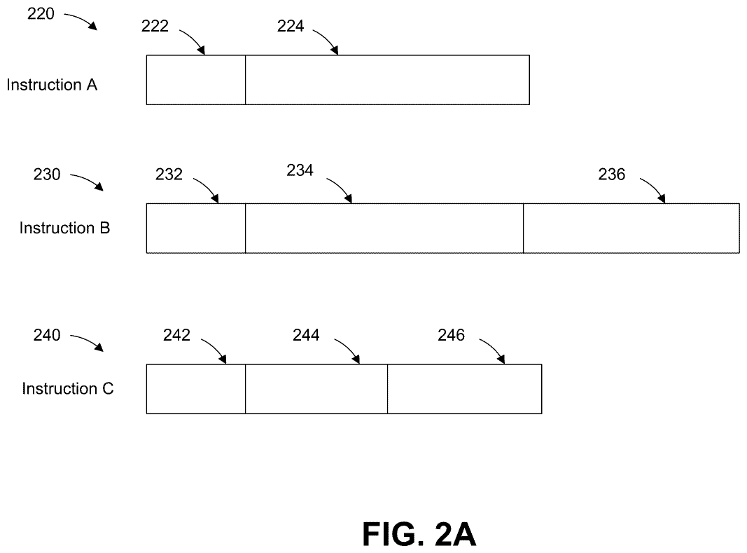

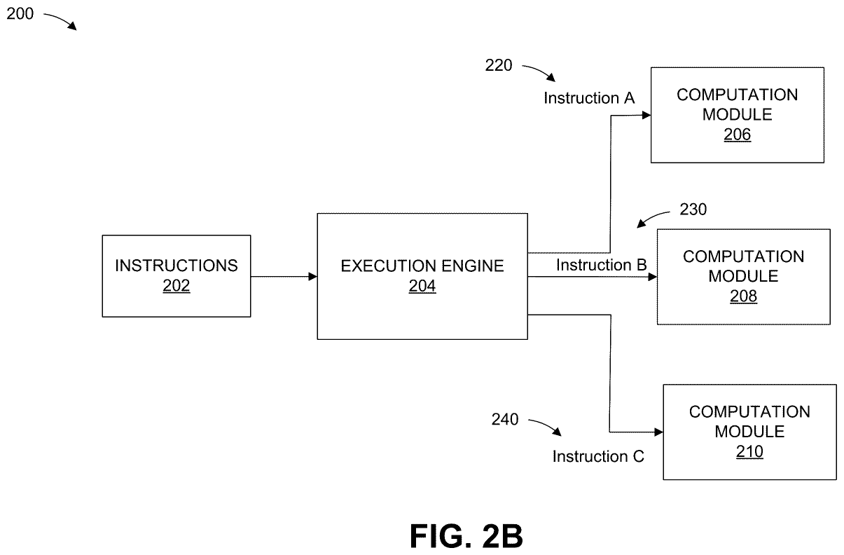

For example, FIG. 2A illustrates different instruction formats that may be detectable by an attacker. In the illustrated example, the instructions 220, 230, 240 can be represented as a sequence of bits. In the illustrated example, instructions 220, 230, 240 include function bits 222, 232, 242 with a fixed number of bits (e.g., 8-bits or 16-bits). Each instruction 220, 230, 240 also includes parameters 224, 234, 236, 244, 246 which can have varying numbers of bits (as indicated by different widths of the parameters. As illustrated, the instructions 220, 230, 240 may also have different numbers of parameters, for example, instruction 220 has one parameter 224, instruction 230 has two parameters, 234, 236, and instruction 240 has two parameters 244, 246. In some cases, the difference in total number of bits, number of parameters, or the like in the instruction format can be detectable by an attack.

For example, FIG. 2B illustrates a simplified example microarchitecture 200 that includes microarchitectural differences in the instruction aspects of different instructions. In the example of FIG. 2A, instructions 202 can be provided to an execution engine 204 (e.g., a microprocessor). In some cases, the instructions 202 can correspond to instructions 220, 230, 240 of FIG. 2A. In some cases, execution of the instructions 202 can include operations performed by computation modules 206, 208, 210. Example computation modules can include, without limitation, registers, arithmetic logic units, multiply-accumulate (MAC) blocks, multiply-add (MAD) blocks, or the like. In the example of FIG. 2B, operations for instruction 220 are performed by computational module 206, operations for instruction 230 are performed by computation module 208, and operations for instruction 240 are performed by computation module 210. In some cases, the operations performed by each of the different computation modules 206, 208, 210 may be detectable by an attacker. For example, the operations performed by computation module 208 during execution of instruction 230 may correspond to a security operation that interfaces with security information assets. In some implementations, the computation modules 206, 210 may perform general operations during execution of the instructions 220, 240. In some cases, security operations can be developed at the software level to obscure security information assets. However, microarchitectural differences in instruction aspect and/or execution as described with respect to FIG. 2A and FIG. 2B may make obscuring security information assets more difficult.

Accordingly, it would be beneficial to provide a microarchitecture for secure computing systems that reduces differences in instruction aspect and/or execution of security operations and general operations to improve security for security information assets.

Systems, apparatuses, electronic devices, methods (also referred to as processes), and computer-readable media (collectively referred to herein as “systems and techniques”) are described herein for providing microarchitectures for secure computing systems. In some examples, a microarchitecture for secure computing systems (e.g., within a secure execution environment) can be designed with microarchitectural protections that can protect security information assets automatically at the processor level. For example, a processor microarchitecture can be designed to execute operations that interact with security information assets (e.g., security operations) and instructions that do not interact with security information assets that do not interact with security information (e.g., general operations) in a manner that obscures the timing of security operations. For example, the instructions executed within a secure execution environment may be configured to have a common instruction aspect. For example, the instructions having a common instruction aspect executed within a secure execution environment can be configured with similar (or identical) instruction fetch timing, similar (or identical) instruction processing timing, identical instruction Hamming weight, identical instruction length (e.g., by including dummy parameters to match instruction length), similarity in communication with one or more computation modules of the plurality of computation modules (e.g., computation modules 206, 208, 210 of FIG. 2B) used during instruction execution, similarity in use of the one or more computation modules of the plurality of computation modules used during instruction execution, and/or any combination thereof. In some examples, both security operations and general operations can be extended by a variable number of dummy cycles. As used herein, dummy cycles refer to cycles that are executed in response to an instruction that are not required for completion of the instruction. Dummy cycles can be added before and/or after the cycles executed in response to the instruction that are required for completion of the instruction.

In some cases, by extending operations by a random number of cycles a particular operation performed at two different times can incorrectly appear, to an attacker, to be two different instructions. In some cases, the microarchitectural protections can include performing general operations, security operations, and/or dummy operations in parallel. As used herein, operations performed in parallel refer to operations that are executed at least partially overlapping in time. In some cases, operations performed in parallel can be performed, in whole or in part, by different computation modules (e.g., computation modules 206, 208, 210 of FIG. 2B). In another illustrative example, the microarchitectural protections can included correctness checks that can be used to detect attempts to perturbate execution of operations. Such instruction aspect design, variable operation timing, dummy operations, and/or correctness check operations may obfuscate the security information asset such that attackers (e.g., performing side channel attacks, fault injection attacks, etc.) may be less likely to discern all or any portion of the security information asset, and, as such, be less able to compromise the security of a computing device.

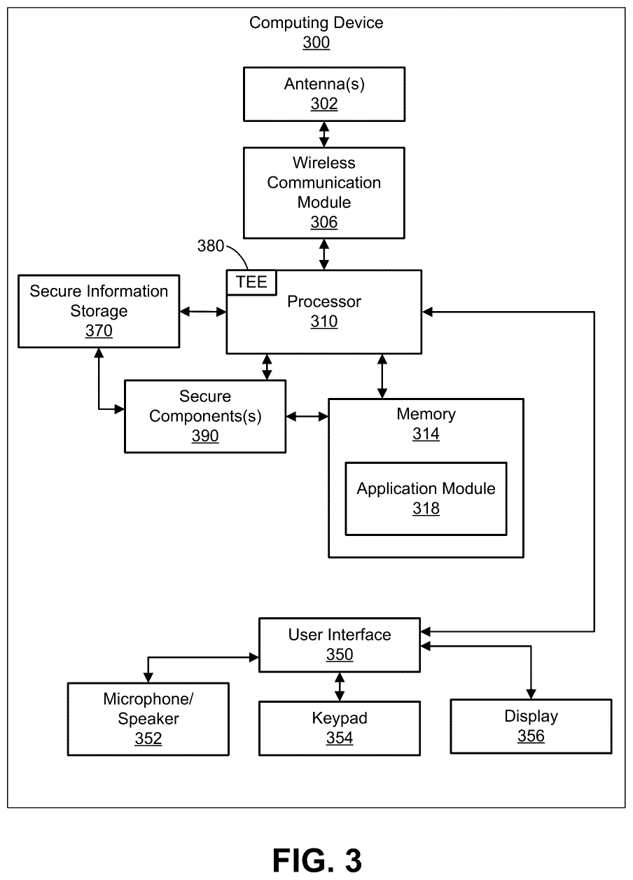

Various aspects of the systems and techniques described herein will be discussed below with respect to the figures. According to various examples, FIG. 3 is a diagram illustrating an example computing device 300. The computing device 300. The computing device 300 may include, but is not limited to, any of the following: one or more processors (e.g., components that include integrated circuitry, memory, input and output device(s) (not shown), non-volatile storage hardware, one or more physical interfaces, any number of other hardware components (not shown), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IoT) device, a server (e.g., a blade-server in a blade-server chassis, a rack server in a rack, etc.), a desktop computer, a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a network-connected watch or smartwatch, or other wearable device), a robotic device, a smart television, a smart appliance, an extended reality (XR) device (e.g., augmented reality (AR), virtual reality (VR), etc.), any device that includes one or more SoCs, and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

As illustrated, the computing device 300 may include one or more antennas 302, one or more wireless communication modules 306, a processor 310, memory 314, user interface 350, microphone/speaker 352, keypad 354, display 356, secure information storage 370, trusted execution environment 380, and secure components 390.

As shown, the computing device 300 may include one or more wireless communication modules 306 that may be connected to one or more antennas 302. The one or more wireless communication modules 306 comprise suitable devices, circuits, hardware, and/or software for communicating with and/or detecting signals to/from an access point, a network, a base station, and/or directly with other wireless devices within a network.

In some implementations, the one or more wireless communication modules 306 may comprise a CDMA communication system suitable for communicating with a CDMA network of wireless base stations. In some implementations, the wireless communication system may comprise other types of cellular telephony networks, such as, for example, TDMA, GSM, WCDMA, LTE, NR, and the like. Additionally, any other type of wireless networking technologies may be used, including, for example, WiMax (802.16), Wi-Fi (802.11), and the like.

The processor(s) (also referred to as a controller) 310 may be connected to the one or more wireless communication modules 306. The processor 310 may include one or more microprocessors, microcontrollers, and/or digital signal processors that provide processing functions, as well as other calculation and control functionality. The processor 310 may be coupled to storage media (e.g., memory) 314 for storing data and software instructions for executing programmed functionality within the mobile device. The memory 314 may be on-board the processor 310 (e.g., within the same IC package), and/or the memory may be external memory to the processor and functionally coupled over a data bus.

A number of software engines and data tables may reside in memory 314 and may be utilized by the processor 310 in order to manage communications, perform positioning determination functionality, and/or perform device control functionality. In some cases, the memory 314 may include an application engine 318. It is to be noted that the functionality of the modules and/or data structures may be combined, separated, and/or be structured in different ways depending upon the implementation of the computing device 300.

The application engine 318 may include a process running on the processor 310 of the computing device 300, which may request data from one of the other modules of the computing device 300. Applications typically run within an upper layer of the software architectures and may be implemented in a rich execution environment of the computing device 300, and may include indoor navigation applications, shopping applications, financial services applications, social media applications, location aware service applications, etc.

In some examples, the computing device 300 includes the secure information storage 370. In some examples, the secure information storage 370 can be any storage device configured to store security information assets (e.g., cryptographic keys, metadata, etc.). For instance, the secure information storage 370 is where security information assets are stored and initially obtained from when needed for use on a computing device (e.g., for encryption and/or decryption of data). In some cases, the secure information storage 370 can include a key store or a key table. Examples of secure information storage 370 include, but are not limited to, various types of read-only memory, one time programmable memory devices (e.g., one time programmable fuses or other types of one time programmable memory devices), non-volatile memory, etc. The secure information storage 370 may be operatively connected to the trusted execution environment 380 and/or the secure components 390. Although FIG. 3 shows the computing device 300 as including a single secure information storage 370, the computing device 300 may include any number of secure information storages without departing from the scope of examples described herein.

The processor 310 may include a trusted execution environment 380. The trusted execution environment 380 may also be referred to as a trusted management environment, trust zones, trusted platform modules, or the like. The trusted execution environment 380 can be implemented as a secure area of the processor 310 that can be used to process and store sensitive data in an environment that is segregated from the rich execution environment in which the operating system and/or applications (such as those of the application engine 318) may be executed. The trusted execution environment 380 can be configured to execute secure applications (also referred to as trusted applications) that provide end-to-end security for sensitive data by enforcing confidentiality, integrity, and protection of the sensitive data stored therein. The trusted execution environment 380 can be used to store encryption keys, access tokens, and other sensitive data.

The computing device 300 may include one or more secure components 390. In some cases, the secure components 390 can be referred to as trusted components, secure elements, trusted elements, or the like. The computing device 300 may include the secure components 390 in addition to or instead of the trusted execution environment 380. The secure components 390 can comprise autonomous and tamper-resistant hardware that can be used to execute secure applications and the confidential data associated with such applications. The secure components 390 can be used to store encryption keys, access tokens, and other sensitive data. The secure components 390 can comprise a Near Field Communication (NFC) tag, a Subscriber Identity Module (SIM) card, or other type of hardware device that can be used to securely store data. The secure components 390 can be integrated with the hardware of the computing device 300 in a permanent or semi-permanent fashion or may, in some implementations, be a removable component of the computing device 300 that can be used to securely store data and/or provide a secure execution environment for applications.

Examples of secure applications that may be performed by the computing device 300, processor 310, secure information storage 370, trusted execution environment 380, secure components 390, and/or any combination thereof include, but are not limited to, encrypting data, decrypting data, key derivation, performing data integrity verification, and performing authenticated encryption and decryption. In some examples, the computing device 300 and/or portions thereof can be configured to perform the various cryptographic service types by being configured to execute one or more cryptographic algorithms. As an example, to perform encryption and decryption, one or more components (e.g., secure information storage 370, trusted execution environment 380, secure components 390) of the computing device 300 may be configured to execute one or more of the Advanced Encryption Standard XOR-encrypt-XOR Tweakable Block Ciphertext Stealing (AES-XTS) algorithm, the AES-Cipher Block Chaining (AES-CBC) algorithm, the AES-Electronic Codebook (AES-EBC) algorithm, the Encrypted Salt-Sector Initialization Vector-AES-CBC (ESSIV-AES-CBC) algorithm, etc., including any variants of such algorithms (e.g., 128 bits, 192 bits, 256 bits, etc.). As another example, to perform integrity verification, one or more components of the computing device 300 may be configured to execute a hash algorithm such as, for example, the one or more members of the SHA family of hash algorithms. As another example, to perform authenticated encryption, one or more components of the computing device 300 may be configured to perform the AES-Galois/Counter Mode (GCM) algorithm. In some aspects, one or more components of the computing device 300 may be configured to execute any other cryptographic algorithms without departing from the scope of examples described herein.

The computing device 300 may further include a user interface 350 providing suitable interface systems, such as a microphone/speaker 352, a keypad 354, and/or a display 356 that allows user interaction with the computing device 300. The microphone/speaker 352 can provide for voice communication services (e.g., using the one or more wireless communication modules 306). The keypad 354 may comprise suitable buttons for user input. The display 356 may include a suitable display, such as, for example, a backlit LCD display, and may further include a touch screen display for additional user input modes.

While FIG. 3 shows a certain number of components in a particular configuration, one of ordinary skill in the art will appreciate that the computing device 300 may include more components or fewer components, and/or components arranged in any number of alternate configurations without departing from the scope of examples described herein. Additionally, although not shown in FIG. 3, one of ordinary skill in the art will appreciate that the computing device 300 may execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 3. The components shown in FIG. 3 may or may not be discrete components. In some aspects, one or more of the components can be combined into different hardware elements, implemented in software, and/or otherwise implemented using software and/or hardware. As used herein, the term device may be a discrete component or apparatus, or may not be a discrete component. In some aspects, other devices can exist within, be part of, and/or utilize the same hardware components as a device.

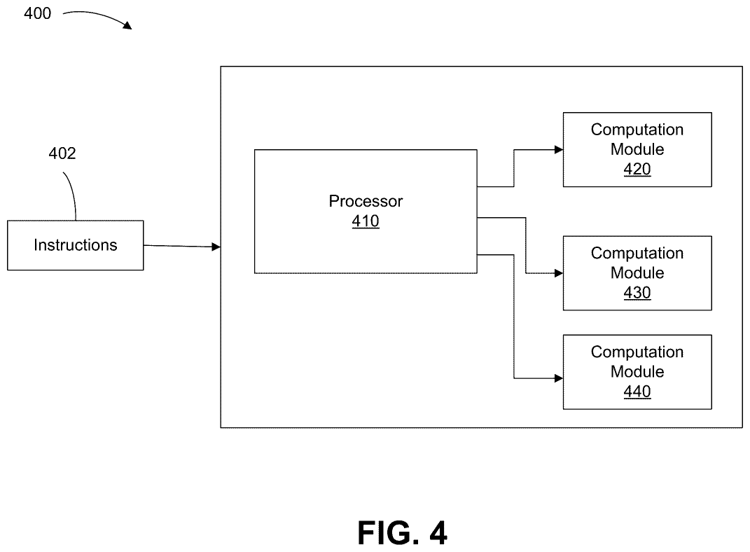

FIG. 4 illustrates an example microarchitecture 400 for secure computing systems. In some cases, the microarchitecture 400 can include and/or be included in the computing device 300, processor 310, secure information storage 370, trusted execution environment 380, secure components 390. As illustrated, the microarchitecture 400 can include a processor 410, and computation modules 420, 430, 440.

As described above with respect to FIG. 2A and FIG. 2B, in some cases, a microarchitecture can process instructions that have unique features. For example, as described with respect to FIG. 2B, the instructions 220, 230, 240 can have different instruction aspects. Example instruction aspects include, without limitation, fetch timing, instruction processing timing, Hamming weight, instruction length, and/or any combination thereof. In some cases, the instruction aspects may also include the hardware computation modules that perform the operation associated with an instruction. For example, a fetch operation may be performed by a storage device, register, or memory. Other instructions may be performed by an arithmetic logic unit (ALU).

In the example microarchitecture 400 of FIG. 4, the instructions 402 can include security operations and general operations. For example, during boot, the microarchitecture 400 may be used to perform security operations (e.g., decrypting and/or encrypting security information assets) as well as general operations (e.g., add, branch, shift, load, Boolean operations, or the like). In some cases, a microarchitecture 400 can include a subset of security instructions that are only used during security operations. In some cases, if the instruction aspect of a security instruction differs from instruction aspects of other security instructions and/or general instructions (e.g., any instruction that is not exclusive to security operations), an attack may be able to detect security instructions using a side channel attack.

In some implementations, the set of instructions supported by microarchitecture 400, including security instructions and general instructions, can be designed to have common instruction aspects that are not easily distinguished. In some cases, the instructions having a common instruction aspect executed within a secure execution environment can be configured with similar (or identical) instruction fetch timing, similar (or identical) instruction processing timing, identical instruction Hamming weight, identical instruction length (e.g., by including dummy parameters to match instruction length), similarity in communication with one or more computation modules of the plurality of computation modules (e.g., computation modules 206, 208, 210 of FIG. 2B) used during instruction execution, similarity in use of the one or more computation modules of the plurality of computation modules used during instruction execution, and/or any combination thereof. In one illustrative example, similarity in use of the one or more computation modules can include utilizing at least one common computation module (e.g., computation module 420, 430, or 440) during execution of a security instruction and execution of a general instruction. In some cases, dummy operations can use at least one common computation module with operations performed while executing a general instruction, a security instruction, and/or other instructions.

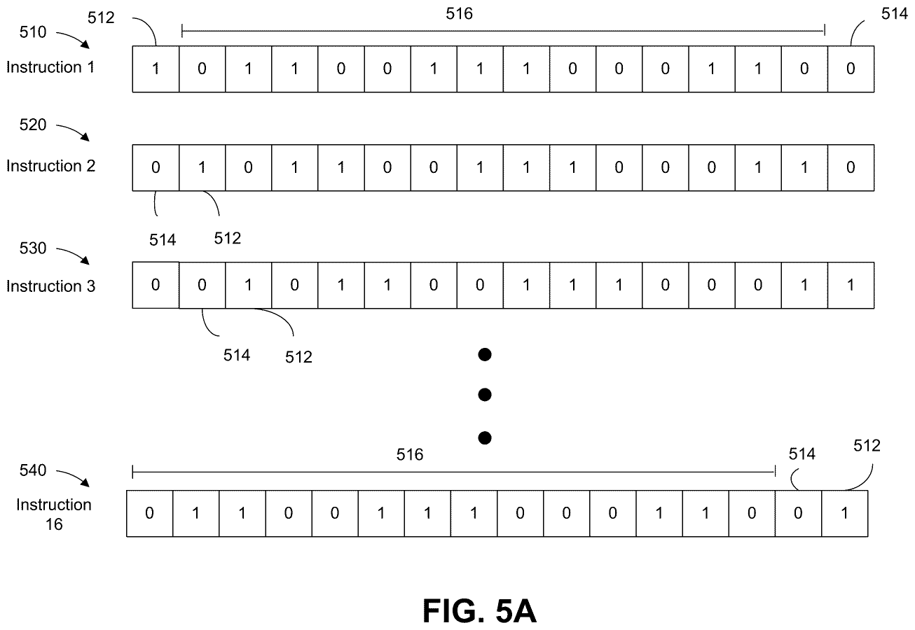

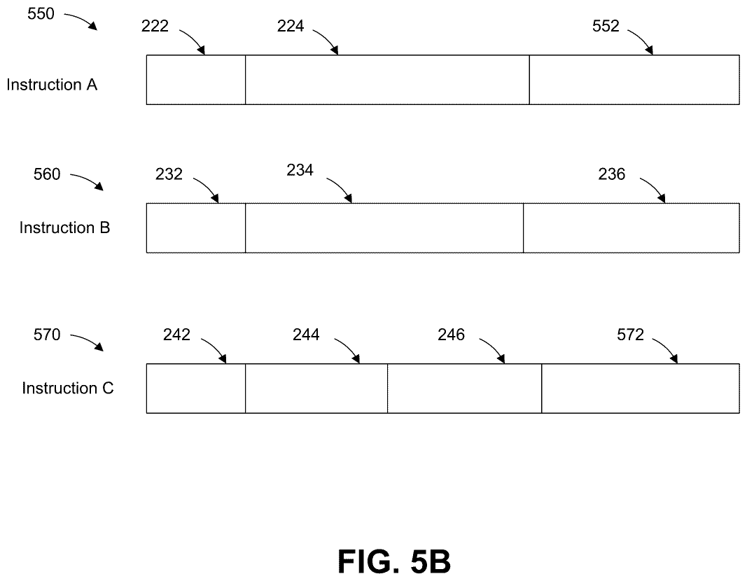

FIG. 5A illustrates a simplified example of an instruction format that can be used by the microarchitecture 400. In the example of FIG. 5A, instructions 510, 520, 530, and 540 are illustrated as a set of sixteen instructions that have a length of 16 bits. As illustrated in FIG. 5A, instructions 510, 520, 530, 540 (and the remaining 12 instructions) include a sequence of bits that is repeated in each instruction but shifted by 1 bit between successive instructions of the instruction set. For example, in the first instruction 510, the first bit of the first instruction 510 is the sequence initial bit 512 illustrated as a “1” and the last bit of the first instruction 510 is the sequence final bit 514 is illustrated as a “0” with the sequence remaining bits 516 making up the first instruction 510. As illustrated, the second instruction 520 includes the sequence of bits rotated right by one bit, with the sequence final bit 514 wrapping around to become the first bit of the second instruction 520, the second bit of the second instruction 520 is the sequence initial bit 512, and the last bit of the second instruction 520 is the last bit of the sequence remaining bits 516. The third instruction 530 is shifted by one additional bit to the right relative to the second instruction 520 as illustrated. In the illustrative example of FIG. 5A, the first bit of the sixteenth instruction 540 is the first bit of the sequence remaining bits 516, the penultimate bit is the sequence final bit 514, and the last bit is the sequence initial bit 512. As noted above, FIG. 5A provides a simplified representation of an instruction set to illustrate one example concept for making instruction format highly uniform to make detection of different instructions used by the microarchitecture 400 in a side channel attack more difficult. For example, making the instruction format highly uniform can create false positives when the same specific patterns of binary data that occur in one instruction may also appear at multiple places in other instructions.

FIG. 5B illustrates an example modification to the instructions 220, 230, 240 of FIG. 2B. For example, instructions 550, 560, 570 of FIG. 5B can correspond to instructions 220, 230, 240 of FIG. 2B, respectively. In the example of FIG. 5B, an instruction 550 is formed by adding a dummy parameter 552 to the function bits 222 and parameter 224 of instruction 220 of FIG. 2B. Similarly, instruction 570 is formed by adding a dummy parameter 572 to the function bits 242 and parameters 244, 246 of instruction 240 of FIG. 2B. As illustrated, the length of the instructions 550, 560, 570 are equalized by adding dummy parameters. In one illustrative example, the dummy parameters can include sequences of data that provide a similar instruction aspect to other, instructions that utilize corresponding bits for parameters utilized in the execution of the instruction. In one illustrative example, the dummy parameter 552 of instruction 550 can be configured to mimic the parameter 236 of instruction 560. In some cases, adding the dummy parameters 552, 572 can make distinguishing different operations (e.g., security operations, general operations) more difficult.

FIG. 5A and FIG. 5B provide illustrative basic examples techniques for designing a more secure instruction set encoding for the microarchitecture 400 to obscure differences between instructions 402. In some cases, the techniques described with respect to FIG. 5A and FIG. 5B can be combined to achieve a level of security that is greater than the level of security provided by performing either of the individual techniques individually. It should be understood that other techniques can be used to obscure differences between instructions without departing from the scope of the present disclosure. can be used without departing from the scope of the present disclosure. In some examples, additional techniques can be combined with one or more of the techniques described herein to achieve additional levels of security.

Returning to FIG. 4, the processor 410 can obtain the instructions 402 and execute the corresponding operations indicated in the instructions. In some cases, the processor 410 can be implemented as a microprocessor. For example, in some cases, a reduced instruction set computer (RISC) processor with a limited instruction set may be used. In some cases, a relatively low instruction count of a RISC processor can mean that the variety of instruction aspects may be relatively small (e.g., when compared to a complex instruction set computer (CISC) processor). As noted above with respect to FIG. 2B, different types of instructions may utilize different computation modules (e.g., computation module 420, computation module 430, and/or computation module 440) to carry out the security operation or general operation contained in an instruction. In some cases, the operation being performed to carry out an operation can be obscured by simultaneously performing dummy operations. For example, when computation module 420 is executing a security operation, computation module 430 and/or computation module 440 may execute dummy instructions. Similarly, when computation module 430 is executing a general operation, computation module 420 and/or computation module 440 may execute dummy instructions. In some cases, computation modules used for executing dummy instruction in some instructions may be used during the execution of other instructions. In some examples, computation modules used for executing dummy instructions may only ever be used to execute dummy instructions. In some cases, computation modules used for executing dummy instructions can be modules capable of performing the security operations and/or the general operations. For example, a computation module that is not required for completing a particular operation may nevertheless be used to perform a computation during the operation to force repeated operation of computation modules at multiple periods of time. In one illustrative example, a computation module that is required to execute one or more security instructions but is not required to execute a particular general operation may nonetheless be activated for a dummy operation during the particular general operation.

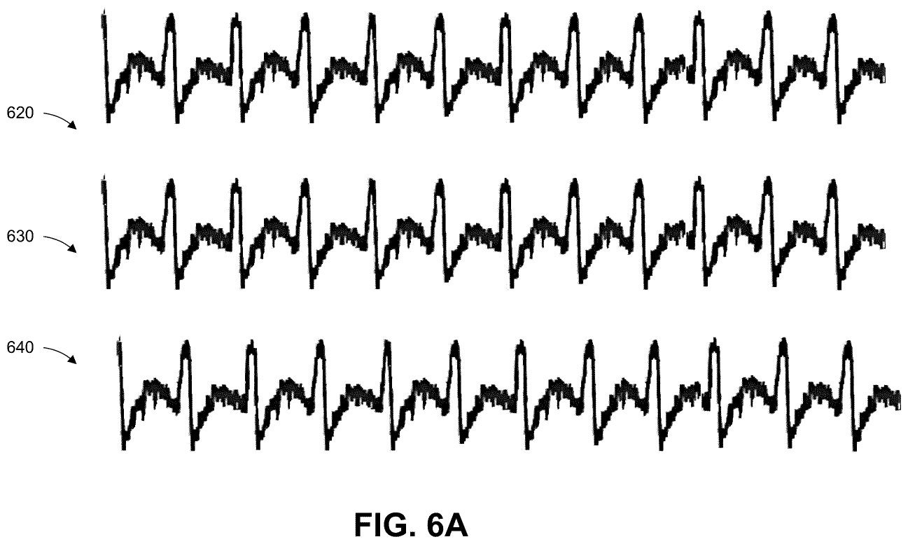

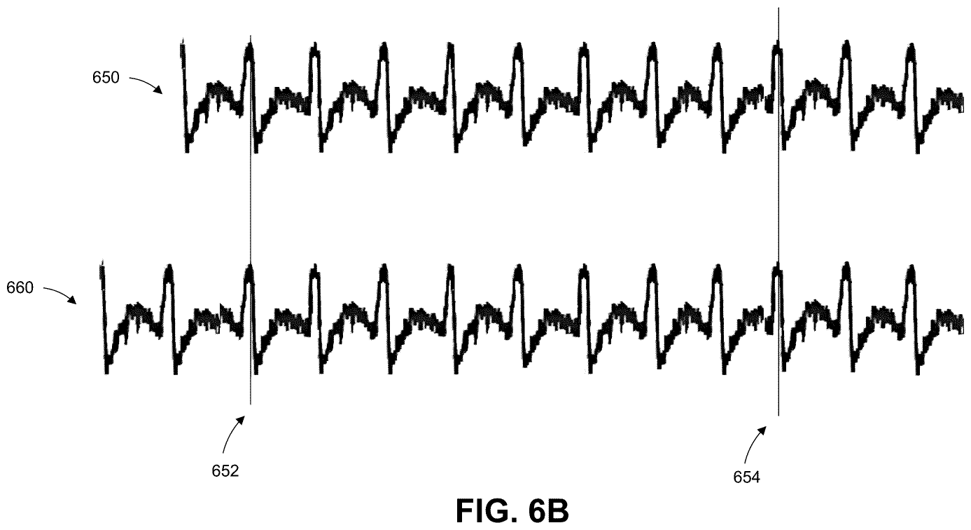

FIG. 6A illustrates example waveforms of computations that may occur in parallel in the microarchitecture 400 of FIG. 4. As described in more detail below, some or all of the waveforms 620, 630, 640 can correspond to dummy instructions. In some cases, one of the waveforms (e.g., waveform 620) may correspond to an operation contained in the instructions 402 of FIG. 4 while the other waveforms (e.g., waveforms 630, 640) may correspond to dummy operations. In another example, a different waveform (e.g., waveform 630) can correspond to an operation contained in the instructions 402 of FIG. 4 while the other waveforms (e.g., waveforms 620, 640) may correspond to dummy operations. In some cases, two or more of the waveforms may correspond to operations included in the instructions 402 of FIG. 4 and the remaining waveforms can correspond to dummy instructions. In some cases, all of the waveforms 620, 630, 640 may correspond to operations contained in the instructions 402 of FIG. 4. In some cases, all of the waveforms 620, 630, 640 can correspond to dummy instructions.

In some implementations, the number of identifiable cycles within the execution flow and/or the number of dummy instructions included in within the execution flow may vary at different points in time. In some implementations, there may be just one sensitive operation or just one visible cycle on the observable traces (e.g., electrical traces corresponding to circuitry activated during execution of an instruction), but the attacker may also observe a sequence of similar operations most of which being dummies at different times. In some implementations, some of the similar operations will be imitations. In some cases, some of the similar operations will not execute with correct inputs. In some implementations, some of the similar operations may be entirely correct but redundant and their outputs can be discarded and not used in any subsequent operations, in order to prevent any effective perturbation or fault injection attacks.

Returning to FIG. 4, although three computation modules 420, 430, 440 are illustrated in FIG. 4, it should be understood that fewer or more computational modules may be used in a microarchitecture without departing from the scope of the present disclosure. In some implementations, all of the computation modules 420, 430, 440 and any additional computation modules (not shown) can operate whenever an instruction is executed by the processor 410. In some implementations, the number of computational modules, the number of dummy instructions, and/or any combination thereof can be varied to confuse potential attackers by generating variations in the instruction aspect that are not necessarily dependent on the underlying operation(s) being performed.

In some cases, variations in instruction execution can be provided on the individual instructions. Referring to FIG. 6B, the two waveforms 650, 660 represent an identical operation that may be extended by a variable number of cycles before and/or after the operation is actually being carried out. In the example of FIG. 6B, the operation being performed occurs between the time 652 and the time 654. In the waveform 650, the operation is extended by one cycle before and two cycles after execution. In the waveform 660, the operation is extended by two cycles before and two cycles after execution. In one illustrative example, a variable number of dummy cycles between one and ten before the operation and a variable number of dummy cycles between one and ten after the operation can be used to provide additional variation in instruction execution to confuse potential attackers. For example, by varying the number of dummy cycles before and after a security operation, two identical operations may appear to be different. In some cases, two different operations, such as a security operation and a general operation may appear to be the same operation based on the addition of dummy cycles, thereby further obscuring the security operation.

Returning to FIG. 4, in some cases, the introduction of security measures described herein can result in performance degradation (e.g., from dummy cycles and/or dummy operations), increased power consumption (e.g., power consumption from dummy operations), noise generation (e.g., interference with other operations of a computing device 300), complexity of implementation (e.g., modifying instructions to populate dummy parameters), additional chip area (e.g., on a silicon wafer die), additional production costs and/or any combination thereof. In some cases, the impact of the factors listed above can be limited by limiting the microarchitectural protections within a limited perimeter (e.g., within trusted execution environment 380, and/or secure components 390 of FIG. 3).

In some cases the parallel operations described as dummy operations herein may also be used to provide security measures in the microarchitecture 400 of FIG. 4. For example, in some cases, one or more of the dummy operations can include a correctness check. In one illustrative example, a correctness check can be used to detect perturbations that may be used in a side channel attack. In some cases, the correctness checks can be performed during security operations and general operations to prevent attackers from using the presence of correctness checks to distinguish between security operations and general operations. In some cases, a failed correctness check can result in triggering an alarm. In some cases, triggering an alarm can cause the microarchitecture 400 to abort a boot, a re-boot, a data logging event, or an update, to blow a memory fuse, to set or re-set a flag, to erase data, and/or to perform other operations.

As noted above, the computing device 300 and/or the microarchitecture 400 and related techniques described herein can allow a system to provide a secure computing environment that includes security measures at the microarchitectural level. In some examples, security measures can include designing instructions for security operations and general operations to have same or similar instruction aspects. For example, a common instruction format can be used for all of the instructions executed in the secure computing environment. In some cases, implementing a common instruction format can include, without limitation, instructions with identical Hamming weight, bit shifted instructions (e.g., as shown in FIG. 5A), length matched instructions (e.g., by adding dummy parameters to shorter instructions), or the like. In some cases, security measures can include making the execution of security operations and general operations more difficult to distinguish. In some cases, security measures can include variable execution length (e.g., appending dummy cycles before and/or after cycles that occur during instruction execution). In some cases, security measures can include performing dummy operations in parallel with both security operations and general operations. In some aspects, security measures can include performing correctness checks to detect perturbation attacks.

It should be noted that the security measures described herein can be used to supplement other security measures that are implemented in software. For example, dummy operations implemented in the software of security operations may be supplemented by dummy operations implemented at the microarchitecture level to increase the apparent number of operations. In some cases, by increase the number of apparent operations, it can become more difficult for an attacker to pinpoint genuine security operations.

In one illustrative example, a software security for NTT computations may makes 172 calls for NTT computations and the additional of dummy operations at the microarchitecture level (e.g., by microarchitecture 400) may increase the apparent number of NTT computations to between 200 and 400. In another illustrative example, the security measures may add between twenty (20) and forty (20), random r and r.G multiplication events in ECDSA. Additional illustrative example security measures include, without limitation, increasing the number of GF (2\hat{ }13) multiplications in McEliece, BIKE, and/or HQC, increasing the number of rounds of AES from fourteen (14) to twenty (20) up to between twenty (20) and forty (40), and/or increasing the number of apparent repetitive and/or single operations in a similar manner for SHA-256, HMAC-512, SHA-3, and/or RNG seeding.

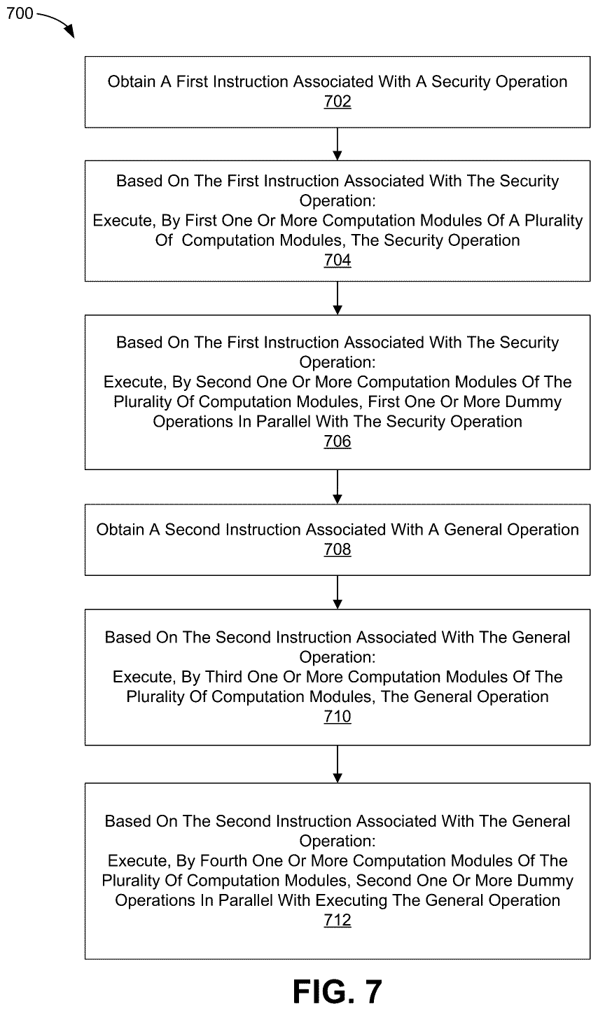

FIG. 7 is a flow diagram of a process 700 for performing security operations, in accordance with aspects of the present disclosure. The process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors.

At block 702, the process 700 includes obtaining a first instruction associated with a security operation. In some cases, the security operation includes interacting with a security information asset (e.g., secure information storage 370, trusted execution environment 380, secure components 390 of FIG. 3). In some aspects, the general operation does not interact with security information assets. In some examples, the security operation includes at least one or more of a number theoretic transform (NTT) computation, a matrix-vector (A*y) multiplication, an elliptic curve digital signature algorithm (ECDSA), elliptic curve point multiplication, security hash algorithms (SHA), McEliece cryptography, bit flipping key encapsulation (BIKE), Hamming quasi-cycling (HQC) encryption, hash-based message authentication code (HMAC), or RNG seeding.

At block 704, the process 700 includes, based on the first instruction associated with the security operation, executing, by first one or more computation modules (e.g., computation modules 206, 208, 210 of FIG. 2B) of a plurality of computation modules, the security operation.

At block 706, the process 700 includes, based on the first instruction associated with the security operation, executing, by second one or more computation modules of the plurality of computation modules, first one or more dummy operations in parallel with the security operation.

At block 708, the process 700 includes obtain a second instruction associated with a general operation.

At block 710, the process 700 includes, based on the second instruction associated with the general operation, executing, by third one or more computation modules of the plurality of computation modules, the general operation

At block 712, the process 700 includes, based on the second instruction associated with the general operation, executing, by fourth one or more computation modules of the plurality of computation modules, second one or more dummy operations in parallel with executing the general operation.

In some cases, the first instruction and the second instruction are configured with a common instruction format (e.g., instructions 510, 520, 530, 540 of FIG. 5A). In some examples, the first instruction and the second instruction are configured with a common instruction aspect (e.g., instructions 550, 560, 570 of FIG. 5B). In some aspects, the common instruction aspect includes at least one or more of repeated patterns, identical instruction length, similar instruction fetch timing, similar instruction processing timing, identical instruction Hamming weight, similarity in communication with one or more computation modules of the plurality of computation modules used during instruction execution, or similarity in use of the one or more computation modules of the plurality of computation modules used during instruction execution.

In some implementations, the first one or more computation modules and the second one or more computation modules used during execution of the first instruction share one or more computation modules in common with the third one or more computation modules and fourth one or more computation modules used during execution of the second instruction.

In some aspects, the first one or more computation modules of the plurality of computation modules executing the security operation and the third one or more computation modules of the plurality of computation modules executing the general operation share one or more common computation modules. In some examples, the first one or more computation modules of the plurality of computation modules executing the security operation and the third one or more computation modules of the plurality of computation modules executing the general operation are different.

In some cases, one or more of the first one or more dummy operations or the second one or more dummy operations is a security operation. In some aspects, execution of the security operation is automatically triggered by a microarchitecture of the processor to be executed in parallel with a general instruction while no security operations are being executed by the processor. In some implementations, one or more of the first one or more dummy operations or the second one or more dummy operations executes with incorrect inputs. In some examples, one or more of the first one or more dummy operations or the second one or more dummy operations is a redundant operation and wherein an output of the redundant operation is discarded.

In some examples, executing one or more of the security operation, the general operation, the first one or more dummy operations, or the second one or more dummy operations includes extending execution of a respective operation by one or more dummy cycles. In some implementations, a number of the one or more dummy cycles is variable for each instruction. In some cases, a particular instruction is executed at a first time with a first input data and extended by a first number of dummy cycles. In some examples, the particular instruction is executed at a second time, different from the first time, with second input data identical to the first input data. In some cases, the particular instruction is extended by a second number of dummy cycles, different from the first number of dummy cycles, at the second time. In some aspects, the first number of dummy cycles and the second number of dummy cycles are determined by a microarchitectural runtime execution feature of the processor. In some examples, the one or more dummy cycles includes one or more of dummy cycles before the respective operation or dummy cycles after the respective operation.

In some cases, one or more of the first one or more dummy operations or the second one or more dummy operations comprises a correctness check configured to determine whether an external perturbation occurred during the correctness check.

In some examples, the first instruction and the second instruction are associated with at least one or more of a boot, a reboot, or an update.

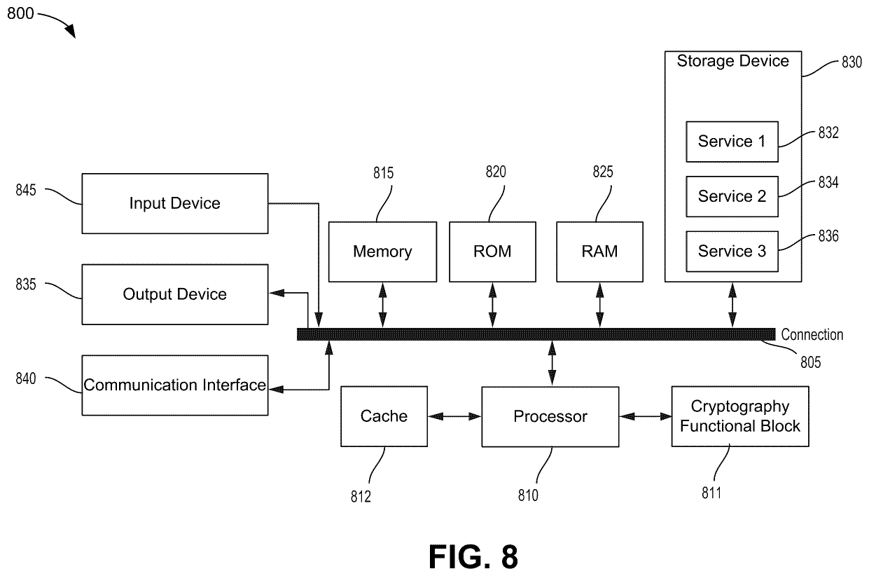

In some examples, the processes described herein (e.g., process 700 and/or other process described herein) may be performed by a computing device or apparatus (e.g., a computing device 300). In another example, the process 700 may be performed by a computing device with the computing system 800 shown in FIG. 8.

FIG. 8 is a diagram illustrating an example of a computing system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some embodiments, computing system 800 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example computing system 800 includes at least one processing unit (CPU or processor) 810 and connection 805 that communicatively couples various system components including system memory 815, such as read-only memory (ROM) 820 and random access memory (RAM) 825 to processor 810. Computing system 800 may include a cache 812 of high-speed memory connected directly with, in close proximity to, or integrated as part of processor 810. The example computing system 800 also includes one or more cryptographical functional blocks 811 connected to the processor. For example, the one or more cryptographical functional blocks 811 can include cryptographical blocks for performing, without limitation, NTT computations, matrix vector multiplication (A*y), r and r.G multiplication (e.g., elliptic curve point multiplication) events (e.g., for an elliptic curve digital signature algorithm (ECDSA)), security hash algorithms, (e.g., SHA-256, SHA-3), McEliece cryptography, bit flipping key encapsulation (BIKE), Hamming quasi-cycling (HQC) encryption, hash-based message authentication code (e.g., HMAC-512), RNG seeding. In some cases, multiple cryptographical functional blocks 811 can be connected to one another directly or indirectly. In some implementations, the one or more cryptographical functional blocks 811 can include one or more co-processing units.

Processor 810 may include any general purpose processor and a hardware service or software service, such as services 832, 834, and 836 stored in storage device 830, configured to control processor 810 as well as a special-purpose processor (e.g., an arithmetic processor, a cryptographic processor, and/or any combination thereof) where software instructions are incorporated into the actual processor design. Processor 810 may essentially be a completely self-contained computing system, containing multiple cores or processors, a bus, memory controller, cache, etc. A multi-core processor may include distinct computation units of variable sizes and features. In some cases, a multi-core processor may be symmetric or asymmetric. In some examples, the one or more cryptographical functional blocks 811 may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (LA) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some embodiments, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, nonvolatile memory express (NVMe) memory, Write Once Read Many (WORM) memory, electronic fuse (eFuse) one-time programmable (OTP), memory, I-fuse OTP memory, gate-oxide breakdown anti-fuse memory, Intel Optane memory, memory, or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X. Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C. or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. An apparatus for secure processing comprising: a memory comprising instructions; and a processor coupled to the memory and configured to: obtain a first instruction associated with a security operation; based on the first instruction associated with the security operation: execute, by first one or more computation modules of a plurality of computation modules, the security operation; and execute, by second one or more computation modules of the plurality of computation modules, first one or more dummy operations in parallel with the security operation; obtain a second instruction associated with a general operation; and based on the second instruction associated with the general operation: execute, by third one or more computation modules of the plurality of computation modules, the general operation; and execute, by fourth one or more computation modules of the plurality of computation modules, second one or more dummy operations in parallel with executing the general operation.

Aspect 2. The apparatus of Aspect 1, wherein the security operation comprises interacting with a security information asset and wherein the general operation does not interact with security information assets.

Aspect 3. The apparatus of any of Aspects 1 to 2, wherein the security operation comprises at least one or more of a number theoretic transform (NTT) computation, a matrix-vector (A*y) multiplication, an elliptic curve digital signature algorithm (ECDSA), elliptic curve point multiplication, security hash algorithms (SHA), McEliece cryptography, bit flipping key encapsulation (BIKE), Hamming quasi-cycling (HQC) encryption, hash-based message authentication code (HMAC), or RNG seeding.

Aspect 4. The apparatus of any of Aspects 1 to 3, wherein one or more of the first one or more dummy operations or the second one or more dummy operations is a security operation, wherein execution of the security operation is automatically triggered by a microarchitecture of the processor to be executed in parallel with a general instruction while no security operations are being executed by the processor.

Aspect 5. The apparatus of any of Aspects 1 to 4, wherein the first one or more computation modules and the second one or more computation modules used during execution of the first instruction share one or more computation modules in common with the third one or more computation modules and fourth one or more computation modules used during execution of the second instruction.

Aspect 6. The apparatus of any of Aspects 1 to 5, wherein the first instruction and the second instruction are configured with a common instruction format.

Aspect 7. The apparatus of any of Aspects 1 to 6, wherein the first instruction and the second instruction are configured with a common instruction aspect, wherein the common instruction aspect comprises at least one or more of repeated patterns, identical instruction length, similar instruction fetch timing, similar instruction processing timing, identical instruction Hamming weight, similarity in communication with one or more computation modules of the plurality of computation modules used during instruction execution, or similarity in use of the one or more computation modules of the plurality of computation modules used during instruction execution.

Aspect 8. The apparatus of any of Aspects 1 to 7, wherein executing one or more of the security operation, the general operation, the first one or more dummy operations, or the second one or more dummy operations comprises extending execution of a respective operation by one or more dummy cycles.

Aspect 9. The apparatus of any of Aspects 1 to 8, wherein a number of the one or more dummy cycles is variable for each instruction.

Aspect 10. The apparatus of any of Aspects 1 to 9, wherein: a particular instruction is executed at a first time with a first input data and extended by a first number of dummy cycles; and the particular instruction is executed at a second time, different from the first time, with second input data identical to the first input data, wherein the particular instruction is extended by a second number of dummy cycles, different from the first number of dummy cycles, at the second time, wherein the first number of dummy cycles and the second number of dummy cycles are determined by a microarchitectural runtime execution feature of the processor.

Aspect 11. The apparatus of any of Aspects 1 to 10, wherein the one or more dummy cycles includes one or more of dummy cycles before the respective operation or dummy cycles after the respective operation.

Aspect 12. The apparatus of any of Aspects 1 to 11, wherein one or more of the first one or more dummy operations or the second one or more dummy operations comprises a correctness check configured to determine whether an external perturbation occurred during the correctness check.

Aspect 13. The apparatus of any of Aspects 1 to 12, wherein one or more of the first one or more dummy operations or the second one or more dummy operations executes with incorrect inputs.

Aspect 14. The apparatus of any of Aspects 1 to 13, wherein one or more of the first one or more dummy operations or the second one or more dummy operations is a redundant operation and wherein an output of the redundant operation is discarded.

Aspect 15. The apparatus of any of Aspects 1 to 14, wherein the first instruction and the second instruction are associated with at least one or more of a boot, a reboot, or an update.

Aspect 16. The apparatus of any of Aspects 1 to 15, wherein the first one or more computation modules of the plurality of computation modules executing the security operation and the third one or more computation modules of the plurality of computation modules executing the general operation share one or more common computation modules.

Aspect 17. The apparatus of any of Aspects 1 to 16, wherein the first one or more computation modules of the plurality of computation modules executing the security operation and the third one or more computation modules of the plurality of computation modules executing the general operation are different.

Aspect 18. A method for secure processing comprising: obtaining a first instruction associated with a security operation; based on the first instruction associated with the security operation: executing, by first one or more computation modules of a plurality of computation modules, the security operation; and executing, by second one or more computation modules of the plurality of computation modules, first one or more dummy operations in parallel with the security operation; obtaining a second instruction associated with a general operation; and based on the second instruction associated with the general operation: executing, by third one or more computation modules of the plurality of computation modules, the general operation; and executing, by fourth one or more computation modules of the plurality of computation modules, second one or more dummy operations in parallel with executing the general operation.

Aspect 19. The method of Aspect 18, wherein the security operation comprises interacting with a security information asset and wherein the general operation does not interact with security information assets.

Aspect 20. The method of any of Aspects 18 to 19, wherein the first one or more computation modules and the second one or more computation modules used during execution of the first instruction share one or more computation modules in common with the third one or more computation modules and fourth one or more computation modules used during execution of the second instruction.

Aspect 21. The method of any of Aspects 18 to 20, wherein the first instruction and the second instruction are configured with a common instruction aspect, wherein the common instruction aspect comprises at least one or more of repeated patterns, identical instruction length, similar instruction fetch timing, similar instruction processing timing, identical instruction Hamming weight, similarity in communication with one or more computation modules of the plurality of computation modules used during instruction execution, or similarity in use of the one or more computation modules of the plurality of computation modules used during instruction execution.

Aspect 22. The method of any of Aspects 18 to 21, wherein executing one or more of the security operation, the general operation, the first one or more dummy operations, or the second one or more dummy operations comprises extending execution of a respective operation by one or more dummy cycles.

Aspect 23. The method of any of Aspects 18 to 22, wherein a number of the one or more dummy cycles is variable for each instruction.

Aspect 24. The method of any of Aspects 18 to 23, wherein: a particular instruction is executed at a first time with a first input data and extended by a first number of dummy cycles; and the particular instruction is executed at a second time, different from the first time, with second input data identical to the first input data, wherein the particular instruction is extended by a second number of dummy cycles, different from the first number of dummy cycles, at the second time, wherein the first number of dummy cycles and the second number of dummy cycles are determined by a microarchitectural runtime execution feature of a processor.

Aspect 25. The method of any of Aspects 18 to 24, wherein the one or more dummy cycles includes one or more of dummy cycles before the respective operation or dummy cycles after the respective operation.

Aspect 26. The method of any of Aspects 18 to 25, wherein one or more of the first one or more dummy operations or the second one or more dummy operations comprises a correctness check configured to determine whether an external perturbation occurred during the correctness check.

Aspect 27. The method of any of Aspects 18 to 26, wherein one or more of the first one or more dummy operations or the second one or more dummy operations executes with incorrect inputs.

Aspect 28. The method of any of Aspects 18 to 27, wherein one or more of the first one or more dummy operations or the second one or more dummy operations is a redundant operation and wherein an output of the redundant operation is discarded.

Aspect 29. The method of any of Aspects 18 to 28, wherein the first one or more computation modules of the plurality of computation modules executing the security operation and the third one or more computation modules of the plurality of computation modules executing the general operation share one or more common computation modules.

Aspect 30. The method of any of Aspects 18 to 29, wherein the first one or more computation modules of the plurality of computation modules executing the security operation and the third one or more computation modules of the plurality of computation modules executing the general operation are different.

Aspect 31. A non-transitory computer-readable storage medium having stored thereon instructions which, when executed by one or more processors, cause the one or more processors to perform any of the operations of aspects 1 to 30.

Aspect 32. An apparatus comprising means for performing a method according to any of Aspects 1 to 30.

What is claimed is:

1. An apparatus for secure processing comprising:
a memory comprising instructions; and
a processor coupled to the memory and configured to:
obtain a first instruction associated with a security operation;
based on the first instruction associated with the security operation:
execute, by first one or more computation modules of a plurality of computation modules, the security operation; and
execute, by second one or more computation modules of the plurality of computation modules, first one or more dummy operations in parallel with the security operation;
obtain a second instruction associated with a general operation; and
based on the second instruction associated with the general operation:
execute, by third one or more computation modules of the plurality of computation modules, the general operation; and
execute, by fourth one or more computation modules of the plurality of computation modules, second one or more dummy operations in parallel with executing the general operation.

2. The apparatus of claim 1, wherein the security operation comprises interacting with a security information asset and wherein the general operation does not interact with security information assets.

3. The apparatus of claim 2, wherein the security operation comprises at least one or more of a number theoretic transform (NTT) computation, a matrix-vector (A*y) multiplication, an elliptic curve digital signature algorithm (ECDSA), elliptic curve point multiplication, security hash algorithms (SHA), McEliece cryptography, bit flipping key encapsulation (BIKE), Hamming quasi-cycling (HQC) encryption, hash-based message authentication code (HMAC), or RNG seeding.

4. The apparatus of claim 1, wherein one or more of the first one or more dummy operations or the second one or more dummy operations is a security operation, wherein execution of the security operation is automatically triggered by a microarchitecture of the processor to be executed in parallel with a general instruction while no security operations are being executed by the processor.

5. The apparatus of claim 1, wherein the first one or more computation modules and the second one or more computation modules used during execution of the first instruction share one or more computation modules in common with the third one or more computation modules and fourth one or more computation modules used during execution of the second instruction.

6. The apparatus of claim 1, wherein the first instruction and the second instruction are configured with a common instruction format.

7. The apparatus of claim 1, wherein the first instruction and the second instruction are configured with a common instruction aspect, wherein the common instruction aspect comprises at least one or more of repeated patterns, identical instruction length, similar instruction fetch timing, similar instruction processing timing, identical instruction Hamming weight, similarity in communication with one or more computation modules of the plurality of computation modules used during instruction execution, or similarity in use of the one or more computation modules of the plurality of computation modules used during instruction execution.

8. The apparatus of claim 1, wherein executing one or more of the security operation, the general operation, the first one or more dummy operations, or the second one or more dummy operations comprises extending execution of a respective operation by one or more dummy cycles.

9. The apparatus of claim 8, wherein a number of the one or more dummy cycles is variable for each instruction.

10. The apparatus of claim 9, wherein:
a particular instruction is executed at a first time with a first input data and extended by a first number of dummy cycles; and
the particular instruction is executed at a second time, different from the first time, with second input data identical to the first input data, wherein the particular instruction is extended by a second number of dummy cycles, different from the first number of dummy cycles, at the second time, wherein the first number of dummy cycles and the second number of dummy cycles are determined by a microarchitectural runtime execution feature of the processor.

11. The apparatus of claim 8, wherein the one or more dummy cycles includes one or more of dummy cycles before the respective operation or dummy cycles after the respective operation.

12. The apparatus of claim 1, wherein one or more of the first one or more dummy operations or the second one or more dummy operations comprises a correctness check configured to determine whether an external perturbation occurred during the correctness check.

13. The apparatus of claim 1, wherein one or more of the first one or more dummy operations or the second one or more dummy operations executes with incorrect inputs.

14. The apparatus of claim 1, wherein one or more of the first one or more dummy operations or the second one or more dummy operations is a redundant operation and wherein an output of the redundant operation is discarded.

15. The apparatus of claim 1, wherein the first instruction and the second instruction are associated with at least one or more of a boot, a reboot, or an update.

16. The apparatus of claim 1, wherein the first one or more computation modules of the plurality of computation modules executing the security operation and the third one or more computation modules of the plurality of computation modules executing the general operation share one or more common computation modules.

17. The apparatus of claim 1, wherein the first one or more computation modules of the plurality of computation modules executing the security operation and the third one or more computation modules of the plurality of computation modules executing the general operation are different.

18. A method for secure processing comprising:
obtaining a first instruction associated with a security operation;
based on the first instruction associated with the security operation:
executing, by first one or more computation modules of a plurality of computation modules, the security operation; and
executing, by second one or more computation modules of the plurality of computation modules, first one or more dummy operations in parallel with the security operation;
obtaining a second instruction associated with a general operation; and
based on the second instruction associated with the general operation:
executing, by third one or more computation modules of the plurality of computation modules, the general operation; and
executing, by fourth one or more computation modules of the plurality of computation modules, second one or more dummy operations in parallel with executing the general operation.

19. The method of claim 18, wherein the security operation comprises interacting with a security information asset and wherein the general operation does not interact with security information assets.

20. The method of claim 18, wherein the first one or more computation modules and the second one or more computation modules used during execution of the first instruction share one or more computation modules in common with the third one or more computation modules and fourth one or more computation modules used during execution of the second instruction.

21. The method of claim 18, wherein the first instruction and the second instruction are configured with a common instruction aspect, wherein the common instruction aspect comprises at least one or more of repeated patterns, identical instruction length, similar instruction fetch timing, similar instruction processing timing, identical instruction Hamming weight, similarity in communication with one or more computation modules of the plurality of computation modules used during instruction execution, or similarity in use of the one or more computation modules of the plurality of computation modules used during instruction execution.

22. The method of claim 18, wherein executing one or more of the security operation, the general operation, the first one or more dummy operations, or the second one or more dummy operations comprises extending execution of a respective operation by one or more dummy cycles.

23. The method of claim 22, wherein a number of the one or more dummy cycles is variable for each instruction.

24. The method of claim 23, wherein:
a particular instruction is executed at a first time with a first input data and extended by a first number of dummy cycles; and
the particular instruction is executed at a second time, different from the first time, with second input data identical to the first input data, wherein the particular instruction is extended by a second number of dummy cycles, different from the first number of dummy cycles, at the second time, wherein the first number of dummy cycles and the second number of dummy cycles are determined by a microarchitectural runtime execution feature of a processor.

25. The method of claim 24, wherein the one or more dummy cycles includes one or more of dummy cycles before the respective operation or dummy cycles after the respective operation.

26. The method of claim 18, wherein one or more of the first one or more dummy operations or the second one or more dummy operations comprises a correctness check configured to determine whether an external perturbation occurred during the correctness check.

27. The method of claim 18, wherein one or more of the first one or more dummy operations or the second one or more dummy operations executes with incorrect inputs.

28. The method of claim 18, wherein one or more of the first one or more dummy operations or the second one or more dummy operations is a redundant operation and wherein an output of the redundant operation is discarded.

29. The method of claim 18, wherein the first one or more computation modules of the plurality of computation modules executing the security operation and the third one or more computation modules of the plurality of computation modules executing the general operation share one or more common computation modules.

30. The method of claim 18, wherein the first one or more computation modules of the plurality of computation modules executing the security operation and the third one or more computation modules of the plurality of computation modules executing the general operation are different.
